(19) United States
(12) Patent Application Publication
(10) Pub. No.: US 2013/0008690 A1
(43) Pub. Date: Jan. 10, 2013

(54) COMPOSITIONS AND METHODS FOR GROWING COPPER NANOWIRES

(75) Inventors: Benjamin Wiley, Durham, NC (US); Aaron Rathmell, Durham, NC (US)

(73) Assignee: DUKE UNIVERSITY, Durham, NC (US)

(21) Appl. No.: 13/514,176

(22) PCT Filed: Dec. 7, 2010
(86) PCT No.: PCT/US10/59236

§ 371 Date: Sep. 12, 2012

Related U.S. Application Data
(60) Provisional application No. 61/267,248, filed on Dec. 7, 2009.
(60) Provisional application No. 61/377,241, filed on Aug. 26, 2010.

(51) Int. Cl. H01B 1/22; H01B 13/00; H01B 7/28; B82Y 40/00; B82Y 30/00

(52) U.S. Cl. 174/120 C; 252/512; 428/401; 420/469; 75/343; 427/123; 977/762; 977/896

(57) ABSTRACT

A method of synthesis to produce gram-scale quantities of copper nanowires in an aqueous solution, wherein the copper nanowires are dispersed in said solution. Copper nanowires grow from spherical copper nanoparticles within the first 5 minutes of the reaction. Copper nanowires can be collected from solution and printed to make conductive films (preferably <10,000 Ω/sq) that preferably transmit greater than 60% of visible light.

### FIELD

The present disclosure relates generally to the field of copper nanowires. Specifically, the present disclosure relates to copper nanowire structures, copper nanowire dispersion compositions, and methods of making said copper nanowires.

### BACKGROUND

Transparent conductors are used in a wide variety of applications, including low-emissivity windows, flat-panel displays, touch-sensitive control panels, solar cells and for electromagnetic shielding (Gordon 2000). The market for flat-panel displays alone is worth approximately $90 billion per year. Display makers prefer to use Indium Tin Oxide (ITO) as the transparent conductor because it can be applied at relatively low temperatures, and is easier to etch than materials with comparable conductivities and transmissivities (Gordon 2000). ITO films can be made with a sheet resistance of 10 Ω/sq transmit about 90% of visible light (Chopra 1983). Limitations of ITO include the fact that a) it is brittle, and thus can not be used in flexible displays, b) the sputtering process used to make ITO films is highly inefficient, depositing only 30% of an ITO target onto a substrate (U.S. Geological Survey, Indium), c) Indium is also a scarce element, present in the earth's crust at concentrations of only 0.05 parts per million (Taylor 1995). The limited supply and increasing demand of indium for use in flat panel displays, which represent 80% of indium consumption, has led to a recent price increase of 745%, from $94/kg in 2002, to about $700/kg today (U.S. Geological Survey, Indium).

The lack of flexibility, inefficient processing, and high cost of ITO films has motivated a search for alternatives. Films of carbon nanotubes have been extensively explored as one possible alternative, but carbon nanotube films have yet to match the properties of ITO (Kaempgen 2005, Lagemaat 2006). More recently, researchers have shown flexible films of silver nanowires have conductivities and transmittances comparable to ITO (De, ACSNano, 2009), but silver is also similar to ITO in price ($500/kg) and scarcity (0.05 ppm) (U.S. Geological Survey, Silver).

Copper is 1000 times more abundant that indium or silver, and is 100 times less expensive. Films of copper nanowires (CuNWs) could thus represent a low-cost alternative to silver nanowires or ITO for use as a transparent electrode. The methods described herein provide for the synthesis of CuNWs on the gram scale, and their transfer to a substrate to make transparent, conductive electrodes with properties comparable to ITO.

### SUMMARY

The present disclosure relates to novel copper nanowire (CuNW) structures, which comprise a nanowire attached to a spherical nanoparticle, a novel dispersion of CuNWs in which they are free from aggregation, and methods of synthesizing nanowires to produce said dispersion at a large scale.

In one aspect, a copper nanowire (CuNW) is described, said CuNW comprising a copper stick attached to a spherical copper nanoparticle. In one embodiment, the copper nanowires further comprise a protective film.

In another aspect, a dispersion of copper nanowires, comprising copper nanowires (CuNWs) and a dispersion solution, wherein the CuNWs are substantially free from aggregation.

In yet another aspect, a method of producing copper nanowires (CuNWs) is described, said method comprising:

mixing a copper (II) ion source, at least one reducing agent, at least one copper capping agent, and at least one pH adjusting species to form a first solution;
maintaining the first solution for time and temperature necessary to reduce the copper (II) ions; adding a second solution comprising water and at least one surfactant to create a mixture; and
maintaining the mixture at time and temperature necessary to form CuNWs.

In still another aspect, a method of producing copper nanowires (CuNWs) is described, said method comprising:

mixing a copper (II) ion source, at least one reducing agent, at least one copper complexing agent, and at least one pH adjusting species to form a first solution;
stirring and heating the first solution for time necessary to reduce the copper (II) ions;
removing the first solution from heat and adding a second solution comprising water and a surfactant to create a mixture;
cooling the mixture for time necessary to form CuNWs.

In yet another aspect, a conductive film comprising a network of copper nanowires (CuNWs) is described, said conductive film having a sheet resistance of less than about 10,000 Ω/sq, preferably less than about 1000 Ω/sq, more preferably less than 100 Ω/sq, and most preferably less than 30 Ω/sq. Preferably, the conductive film has a transparency greater than about 60%, preferably greater than 70%, and most preferably greater than 85%.

In still another aspect, a method of making a conductive film comprising a network of copper nanowires (CuNWs), said conductive film having a sheet resistance of less than about 10,000 Ω/sq, said method comprising printing a CuNWs dispersion onto a substrate. Preferably, the sheet resistance is less than about 1000 Ω/sq, more preferably less than 100 Ω/sq, and most preferably less than 30 Ω/sq, and the conductive film has a transparency greater than about 60%, and transparencies greater than 60%, preferably greater than 70% and most preferably transparencies greater than 85%.

These and other novel features and advantages of the disclosure will be fully understood from the following detailed description and the accompanying drawings.

### BRIEF DESCRIPTION OF THE DRAWINGS

FIG. 1: FIGS. 1A-1B show images of a scale up reaction of the copper nanowire synthesis and the SEM image of copper nanowires reacted at 80° C. for 60 minutes. FIG. 1C is an image of the copper nanowires. The inset is a close-up of the copper nanowires, scale bar is 200 nm.

FIG. 2: FIGS. 2A and 2B are SEM images showing CuNWs growing out of nanoparticles at reaction times=3.5 and 20 minutes respectively.

FIG. 3: FIGS. 3A and 3B are from a CuNW film that are 38% and 67% transparent, respectively, having sheet resistances of 1.5 Ω/sq and 61 Ω/sq, respectively. FIGS. 3C & D show corresponding camera images of CuNW films 35 mm in diameter to visually demonstrate the difference in transparency between these copper nanowire films.

FIG. 4: FIG. 4A shows a plot of % Transmittance versus Sheet resistance in Ω/sq showing thin films composed of the as synthesized CuNWs (filled circles), AgNWs (triangles), ITO (stars), and Carbon Nanotubes (CNTs) (open circles). Error bars show one standard deviation of the CuNW film's sheet resistance. FIG. 4B shows a plot of sheet resistance versus time in days showing the stability of the CuNW film.

FIG. 5: shows CuNW diameter and length versus EDA concentration, respectively. FIG. 5A shows CuNW diameter (nrn) versus EDA concentration (moles L⁻¹). Error bars show one standard deviation for 16-40 measurements. FIG. 5B shows CuNW length (μm) versus EDA concentration (moles L⁻¹). Error bars show one standard deviation for 7-10 measurements.

FIG. 6. Close up view of CuNWs as compared to AgNWs.

FIG. 7 shows a schematic of an embodiment for the synthesis of longer, well-dispersed, copper nanowires.

FIG. 8 shows the effect of surfactant on the generation of CuNWs in accordance with one embodiment of the present disclosure. FIGS. 8A and 8B are graphs showing the PVP to water ratio added to the reaction after the reaction mixture is removed from the hot water bath and their corresponding effect on CuNW diameter and length, respectively. These reactions were completed using a 20 mL small-scale reaction.

FIG. 9 shows the effect of time on the generation of CuNWs in accordance with one embodiment of the present disclosure. FIGS. 9A and 9B are graphs showing the amount of time a reaction spends heating up versus diameter and length, respectively.

FIG. 10 shows the effect of temperature on the generation of CuNWs in accordance with one embodiment of the present disclosure. FIGS. 10A and 10B are graphs showing the effect the amount of time the reaction sat at room temperature versus nanowire diameters and lengths, respectively, for three different reaction temperatures.

FIG. 11 shows that nanowires grown to have the same width but different lengths enable a width-independent analysis of the effects of nanowire length on the conductivity of nanowire films FIG. 11A shows transmittance (at λ=550 nm) versus sheet resistance of nanowires with different lengths. FIG. 11B shows a plot of sheet resistance as a function of wire density. FIG. 11C shows a logarithmic plot of sheet conductance versus nL²−5.71, where 5.71 is nL² required for percolation predicted by theory. The solid line with a slope of 1.33 shows the relationship between conductance and nL² predicted by percolation theory.

FIG. 12 shows transmittance versus sheet resistance of copper nanowire, silver nanowire, carbon nanotube, and indium tin oxide films. The wavelength at which the transmittance was measured is 500 nm.

FIG. 13 shows the transmittance spectrum of copper nanowire, silver nanowire, and indium tin oxide films.

FIG. 14 shows a film of copper nanowires with a conductivity of 9.71±7.4 Ω/sq and a transmittance of 85%.

FIG. 15 is a dark-field microscope image showing scattering of light from the copper nanowires (long copper-colored strands), as well as some circular defects or particles on the substrate.

FIG. 16 is a plot of sheet resistance versus number of bends showing no change in CuNW conductivity after 1000 bends.

FIG. 17 plots the conductivity of nanowire films coated onto glass with a Meyer Rod.

FIG. 18 is an SEM image of Cu nanowires coated with nickel.

FIG. 19 shows the calculated upper bound for the transmittance of conducting network of nanowires with different lengths and widths.

### DETAILED DESCRIPTION OF THE EMBODIMENTS

Unless otherwise defined, all technical terms used herein have the same meaning as commonly understood by one of ordinary skill in the art to which this disclosure belongs.

The articles “a” and “an” are used herein to refer to one or to more than one (i.e. at least one) of the grammatical object of the article. By way of example, “an element” means at least one element and can include more than one element.

The present disclosure relates to a novel copper nanowire (CuNW) structures, which comprise a nanowire attached to a spherical nanoparticle, a novel dispersion of CuNWs in which they are free from aggregation, and methods of synthesizing nanowires to produce said dispersion at a large scale. Transparent electrodes made from these new, well-dispersed copper nanowires perform at the same level as silver nanowires, producing electrodes with sheet resistances under 10,000 Ω/sq, preferably less than about 1000 Ω/sq, more preferably less than 100 Ω/sq, and most preferably less than 30 Ω/sq, and transparencies greater than 60%, preferably greater than 70% and most preferably transparencies greater than 85%.

As defined herein, “capping agent” includes those compounds that are understood by one skilled in the art to alter the assembly of atoms of the growing structure into anisotropic states.

Previous synthetic methods produced copper nanowire dispersions in which the nanowires were aggregated, and that when coated on a transparent substrate did not achieve the favorable conductivity (<30 Ω/sq) at high transmittance (>85%) that had been achieved with silver nanowires.

Surprisingly, the present inventors discovered that dispersions of copper wires having the appropriate characteristics are preferably produced by separating the seed nucleation and nanowire growth steps into two different reaction parts of the reaction. Specifically, after the seeds form or otherwise nucleate, a surfactant solution may be added to the reaction to stabilize the nanowires during their growth. Preferably, the temperature of the solution is also lowered during the growth phase to produce longer nanowires.

Broadly, the present description relates to a method for producing CuNWs on a gram scale, said method comprising, consisting of or consisting essentially of mixing a copper (II) ion source, at least one reducing agent, at least one copper capping agent, and at least one pH adjusting species to form a solution; stirring and heating the solution for time necessary to reduce the copper (II) ions; collecting formed CuNWs; and washing formed CuNWs with a wash solution. For example, a method for producing CuNWs on a gram scale can comprise, consist of or consist essentially of reducing a solution containing Cu(NO₃)₂ and at least one component selected from the group consisting of hydrazine, EDA, NaOH and combinations thereof; stirring and heating the solution at 80° C. for at least 60 minutes until the solution turns from a royal blue color to a reddish brown color, indicating the CuNWs have been formed; and washing the formed CuNWs with hydrazine.

A second aspect relates to a method of producing dispersions of CuNWs comprising, consisting of, or consisting essentially of mixing a copper (II) ion source, at least one reducing agent, at least one copper capping agent, and at least one pH adjusting species to form a first solution; maintaining the first solution for time and temperature necessary to reduce the copper (II) ions; adding a second solution comprising water and at least one surfactant to create a mixture; and maintaining the mixture at time and temperature necessary to form CuNWs. In one embodiment, the method of producing dispersions of CuNWs on the gram scale comprises, consists of or consists essentially of mixing a copper (II) ion source, at least one reducing agent, at least one copper capping agent, and at least one pH adjusting species to form a first solution; stirring and heating the first solution for time necessary to reduce the copper (II) ions; adding a second solution comprising water and at least one surfactant to create a mixture; and cooling the mixture for time necessary to form CuNWs. In another embodiment, the method of producing dispersions of CuNWs on the gram scale comprises, consists of, or consists essentially of mixing a copper (II) ion source, at least one reducing agent, at least one copper capping agent, and at least one pH adjusting species to form a first solution; stirring and heating the first solution for time necessary to reduce the copper (II) ions; removing the first solution from the heat; adding a second solution comprising water and at least one surfactant to create a mixture; and cooling the mixture for time necessary to form CuNWs. In yet another embodiment, the method of producing dispersions of CuNWs comprises, consists of or consists essentially of reducing a solution containing a copper (II) ion source, at least one reducing agent, at least one copper capping agent, and at least one pH adjusting species to form a first solution; stirring and heating the first solution at temperature in a range from about 60° C. to about 100° C. for time necessary to reduce the copper (II) ions; removing the first solution from the heat and adding a second solution comprising water and at least one surfactant to create a mixture; and placing the mixture in an ice bath for time necessary to form CuNWs. Even more preferably, the method of producing dispersions of CuNWs comprises, consists of, or consists essentially of reducing a solution containing Cu(NO₃)₂ and at least one component selected from the group consisting of hydrazine, EDA, NaOH and combinations thereof to form a first solution; stirring and heating the first solution at 80° C. for at least five minutes until the first solution generates a darker hue color; removing the first solution from the heat and adding a second solution comprising water and at least one surfactant, e.g., PVP, to create a mixture; and placing the mixture in an ice bath for at least one hour until the mixture turns a light pink color, indicating CuNWs have been formed. In each case, the formed CuNWs can be collected and washed. Collecting can be effectuated by allowing the mixture to settle, for example for a period ranging from 10 to 15 minutes, wherein the CuNWs are extracted from a layer floating on the surface of the mixture; and washing can be effectuated using an aqueous solution comprising an amine species, a surfactant, or combinations thereof.

It was surprisingly discovered that at least one surfactant is preferentially not added to the first solution until after a time wherein reduction of the copper (II) ions has been effectuated, e.g., after stirring and heating the first solution at temperature in a range from about 60° C. to about 100° C.

In certain embodiments, the first solution is agitated for at least 20 seconds after the addition of each component thereto. In other embodiments, the first solution is stirred at about 200 rpm. In certain embodiments, the washing and collecting comprise, consist of or consist essentially of dispersing the formed CuNWs by vortexing and centrifuging the wash solution, e.g., at 2000 rpm, for at least 15 minutes. In certain other embodiments, the washing of the formed CuNWs is repeated several times. The second solution comprising the water and the surfactant can be mixed prior to the addition to the solution, or alternatively not mixed prior to the addition to the solution. As defined herein, “mixed” corresponds to homogeneity upon combination of the surfactant and water, wherein the solubilized surfactant is homogeneously distributed in the second solution. Accordingly, “not mixed” corresponds to anything less than solution homogeneity.

Copper (II) ion sources contemplated herein include, but are not limited to, copper nitrate, copper sulfate, copper nitrite, copper sulfite, copper acetate, copper chloride, copper bromide, copper iodide, copper phosphate, copper carbonate, and combinations thereof. Preferably, the copper (II) source comprises copper (II) nitrate.

Reducing agents contemplated include, but are not limited to, hydrazine, ascorbic acid, L(+)-ascorbic acid, isoascorbic acid, ascorbic acid derivatives, oxalic acid, formic acid, phosphites, phosphorous acid, sulfites, sodium borohydride, and combinations thereof. Preferably, the reducing agent comprises hydrazine.

Copper capping agents contemplated herein include, but are not limited to, triethylenediamine; ethylenediamine (EDA); propane-1,3-diamine; butane-1,4-diamine; pentane-1,5-diamine; ethylenediaminetetraacetic acid (EDTA), 1,2-cyclohexanediamine-N,N,N′,N′-tetraacetic acid (CDTA), glycine, ascorbic acid, iminodiacetic acid (IDA), nitrilotriacetic acid, alanine, arginine, asparagine, aspartic acid, cysteine, glutamic acid, glutamine, histidine, isoleucine, leucine, lysine, methionine, phenylalanine, proline, serine, threonine, tryptophan, tyrosine, valine, gallic acid, boric acid, acetic acid, acetone oxime, acrylic acid, adipic acid, betaine, dimethyl glyoxime, formic acid, fumaric acid, gluconic acid, glutaric acid, glyceric acid, glycolic acid, glyoxylic acid, isophthalic acid, itaconic acid, lactic acid, maleic acid, maleic anhydride, malic acid, malonic acid, mandelic acid, 2,4-pentanedione, phenylacetic acid, phthalic acid, proline, propionic acid, pyrocatecol, pyromellitic acid, quinic acid, sorbitol, succinic acid, tartaric acid, terephthalic acid, trimellitic acid, trimesic acid, tyrosine, xylitol, salts and derivatives thereof, and combinations thereof. Preferably, the copper capping agent comprises EDA.

pH adjusting species include, but are not limited to, sodium hydroxide; potassium hydroxide; cesium hydroxide; rubidium hydroxide; magnesium hydroxide; calcium hydroxide; strontium hydroxide; barium hydroxide; and compounds of the formula NR¹R²R³R⁴OH, wherein R¹, R², R³ and R⁴ may be the same as or different from one another and are selected from the group consisting of hydrogen, straight-chained or branched C₁-C₆ alkyl (e.g., methyl, ethyl, propyl, butyl, pentyl, and hexyl), and substituted or unsubstituted C₆-C₁₀ aryl, e.g., benzyl. Preferably, the pH adjusting species comprises NaOH, KOH, or a combination of NaOH and KOH.

Surfactants contemplated herein include, but are not limited to, water soluble polymers such as polyethylene glycol (PEG), polyethylene oxide (PEO), polypropylene glycol, polyvinyl pyrrolidone (PVP), cationic polymers, nonionic polymers, anionic polymers, hydroxyethylcellulose (HEC), acrylamide polymers, poly(acrylic acid), carboxymethylcellulose (CMC), sodium carboxymethylcellulose (Na CMC), hydroxypropylmethylcellulose, polyvinylpyrrolidone (PVP), BIOCARE™ polymers, DOW™ latex powders (DLP), ETHOCEL™ ethylcellulose polymers, KYTAMER™ PC polymers, METHOCEL™ cellulose ethers, POLYOX™ water soluble resins, SoftCAT™ polymers, UCARE™ polymers, gum arabic, sorbitan esters (e.g., sorbitan monolaurate, sorbitan monopalmitate, sorbitan monostearate, sorbitan tristearate, sorbitan monooleate, sorbitan trioleate), polysorbate surfactants (e.g., polyoxyethylene (20) sorbitan monolaurate, polyoxyethylene (20) sorbitan monopalmitate, polyoxyethylene (20) sorbitan monostearate, polyoxyethylene (20) sorbitan monooleate, polyoxyethylene sorbitan trioleate, polyoxyethylene sorbitan tristearate), and combinations thereof. Other surfactants contemplated include: cationic surfactants such as cetyltrimethylammonium bromide (CTAB), hexadecyltrimethylammonium bromide (HTAB), cetyltrimethylammonium hydrogen sulfate; anionic surfactants such as sodium alkyl sulfates, eee.g., sodium dodecyl sulfate, ammonium alkyl sulfates, alkyl (C₁₀-C₁₈) carboxylic acid ammonium salts, sodium sulfosuccinates and esters thereof, e.g., dioctyl sodium sulfosuccinate, alkyl (C₁₀-C₁₈) sulfonic acid sodium salts, and the di-anionic sulfonate surfactants DowFax (The Dow Chemical Company, Midland, Mich., USA); and nonionic surfactants such as t-octylphenoxypolyethoxyethanol (Triton X100) and other octoxynols. Most preferably, the surfactant comprises PVP.

The wash solution can comprise, consist of or consist essentially of hydrazine, a surfactant, water, and any combination thereof.

Following the appropriate wash and collection, the CuNWs may be stored in the solution comprising a hydrazine, a surfactant, an alcohol, or combinations thereof. Alcohols contemplated herein include straight chained or branched C₁-C₆ alcohols such as methanol, ethanol, propanol, butanol, pentanol, and hexanol. Preferably, the storage solution comprises, consists of or consists essentially of dispersed CuNWs, water, and hydrazine; dispersed CuNWs, water, hydrazine and PVP; or dispersed CuNWs, water, and ethanol. Accordingly, another aspect of the invention relates to a dispersion of CuNWs generated using the method according to the present disclosure wherein the CuNWs are substantially free from aggregation. More specifically, the CuNW dispersion comprises, consists of or consists essentially of CuNWs and a storage solution, wherein the CuNWs are substantially free of aggregation, and wherein the storage solution comprises a species selected from the group consisting of hydrazine, at least one surfactant, at least one alcohol, water, and a combination thereof. As defined herein, “substantially free” corresponds to less than about 5 wt % of the total weighed amount of CuNWs are aggregated, preferably less than about 2 wt %, and most preferably less than 1 wt % of the total weighed amount of CuNWs are aggregated. In this context, “aggregated” refers to the formation of clumps of nanowires due to their mutual van der Waals attraction. Such clumps may consist of as few as two nanowires, and as many as 10¹² nanowires or more. Formation of clumps is generally not reversible in this context, and thus is preferably prevented in order to ensure the film consists of a network of individual wires, rather than clumps. Clumps reduce the transmittance of films, and do not improve the conductivity. Such clumps can easily be identified in a film with a dark field optical microscope, or a scanning electron microscope. It is preferred that the nanowire film contain a minimal amount of clumps in order to reach properties comparable with ITO (<30 Ω/sq, >85% transmittance).

In another aspect, a novel copper structure is described, said structure comprising a nanowire stick attached to a spherical nanoparticle. The novel copper structure, a CuNw, has a first end and a second end that is generated using the method according to the present disclosure, wherein the CuNW comprises a length of about 1 to 500 microns, a diameter of about 20 to 300 nm, and a spherical particle of about 30 to 1000 nm attached to either the first end or the second end.

The nanowire structure, dispersion and production methods described herein have many practical applications including, but not limited to, (1) the ability to coat the nanowires directly from solution onto both rigid and flexible substrates to produce transparent conductive films that can subsequently be patterned; (2) the ability to use printing processes with conductive inks incorporating copper nanowires to make conductive metal lines, shapes, characters, patterns, etc.; and (3) the ability to use the copper nanowires as an additive to pastes, glues, paints, plastics, and composites to create electrically conductive materials.

Accordingly, another aspect relates to a method further of printing the formed CuNWs onto substrates for use as conductive films. For example, the formed CuNWs may be coated directly from solution onto rigid substrates, flexible substrates, or combinations thereof, to produce conductive films that can be subsequently patterned. Preferably, the conductive films are transparent and made from the CuNWs prepared using the processes described herein, wherein said transparent conductive films perform similarly to silver nanowires by having sheet resistances less than about 10,000 Ω/sq, preferably less than about 1000 Ω/sq, more preferably less than 100 Ω/sq, and most preferably less than 30 Ω/sq, and transparencies greater than about 60%, preferably greater than about 70%, and most preferably greater than about 85%. In general, any coating method, including those that are used in web coating or roll-to-roll processes, that involves deposition of material from a liquid phase onto a substrate can be applied to making films of nanowires. Examples of such coating processes include the Mayer rod process, air-brushing, gravure, reverse roll, knife over roll, metering rod, slot die, immersion, curtain, and air knife coating. In one embodiment, a method of producing a conductive copper-containing film is described, said method comprising depositing a layer of CuNWs from a CuNW dispersion onto a substrate using a coating process. The film can comprise, consist of or consist essentially of a network of CuNWs or a network of CuNWs and at least one supportive material, wherein the supportive material includes, but is not limited to, cellulose materials, glues, polymeric materials, or general overcoat materials, e.g., oxygen and moisture impervious bathers, as readily known by one skilled in the art. Preferably the sheet resistance of the copper-containing film is less than about 10,000 Ω/sq, more preferably less than about 1000 Ω/sq, even more preferably less than 100 Ω/sq, and most preferably less than 30 Ω/sq. As defined herein, a “network” corresponds to an arrangement of wires such that the wires are interconnected. For a copper nanowire film to be conductive, at least one path of interconnected wires must traverse between the electrodes where electrical contact is made. In another embodiment, a method of producing a conductive, transparent copper-containing film is described, said method comprising depositing a layer of CuNWs from a CuNW dispersion onto a substrate using a coating process. The film can comprise, consist of or consist essentially of a network of CuNWs or a network of CuNWs and at least one supportive material, wherein the supportive material includes, but is not limited to, cellulose materials, glues, polymeric materials, or general overcoat materials, as readily known by one skilled in the art. Preferably, the sheet resistance of the copper-containing film is less than about 10,000 Ω/sq, more preferably less than about 1000 Ω/sq, even more preferably less than 100 Ω/sq, and most preferably less than 30 Ω/sq, and the transparency greater than about 60%, preferably greater than about 70%, and most preferably greater than about 85%. The copper-containing films preferably are used as transparent electrodes. As defined herein, a “film” of nanowires corresponds to a thin covering of nanowires on a surface. The film may consist solely of nanowires, or of nanowires with supportive materials. For the film to be conducting, the nanowires preferably form an interconnecting network within the film.

Further, any method that can be used to pattern deposition of material can be used to pattern films of nanowires including, but not limited to, Ink Jet, Gravure, Screen, and other printing processes. For this application, nanowires can be suspended in an organic or aqueous solution at an appropriate concentration to make a conducting film. Nanowires can also be suspended in photocurable monomer mixtures and selectively cured with UV light to create a pattern of conductive material. Nanowires can also be patterned with subtractive processes. For example, after casting a film of nanowires onto a surface, specific areas can be chemically etched away or a sticky rubber stamp can be applied to remove the nanowires.

In another aspect, subsequent to the extraction of the synthesized nanowires from the reaction vessel, the unused reaction ingredients are utilized in further synthesis cycles, which advantageously reduces the cost of nanowire production, as well as waste. In a preferred embodiment, the method for recycling ingredients from a prior production of CuNWs to produce CuNWs on a gram scale comprises, consists of or consists essentially of collecting the CuNWs from the mixture; and reusing the solution comprising the basic species, wherein the copper (II) ion source and optionally additional basic species are replenished to produce new solution.

In another aspect, the rate of oxidation of the CuNWs may be reduced by annealing or by forming protecting films on the CuNWs. Copper is widely used in the chemical and electronics industry, and many techniques have been developed to protect copper from oxidation. Many organic molecules are known to protect copper from corrosion, e.g., benzotriazole, tolyltriazole, 1,2,4-triazole (TAZ), 5-phenyl-benzotriazole, 5-nitro-benzotriazole, 3-amino-5-mercapto-1,2,4-triazole, 1-amino-1,2,4-triazole, hydroxybenzotriazole, 2-(5-amino-pentyl)-benzotriazole, 1-amino-1,2,3-triazole, 1-amino-5-methyl-1,2,3-triazole, 3-amino-1,2,4-triazole, 3-mercapto-1,2,4-triazole, 3-isopropyl-1,2,4-triazole, 5-phenylthiol-benzotriazole, halo-benzotriazoles (halo=F, Cl, Br or I), naphthotriazole, 2-4-methyl-2-phenylimidazole, 2-mercaptothiazoline, 5-aminotetrazole, 2,4-diamino-6-methyl-1,3,5-triazine, thiazole, triazine, methyltetrazole, 1,3-dimethyl-2-imidazolidinone, 1,5-pentamethylenetetrazole, 1-phenyl-5-mercaptotetrazole, diaminomethyltriazine, imidazoline thione, mercaptobenzimidazole, 4-methyl-4H-1,2,4-triazole-3-thiol, 5-amino-1,3,4-thiadiazole-2-thiol, benzothiazole, imidazole, indiazole, butyl benzyl triazole, dithiothiadiazole, alkyl dithiothiadiazole and alkylthiols, 2-aminopyrimidine, 5,6-dimethylbenzimidazole, 2-amino-5-mercapto-1,3,4-thiadiazole, 2-mercaptopyrimidine, 2-mercaptobenzoxazole, 2-mercaptobenzothiazole, 2-mercaptobenzimidazole, and combinations thereof. Copper can also be coated or alloyed with nickel, gold, tin, zinc, silver, and other metals to prevent corrosion. Alloying with nickel has the additional benefit of conferring a silvery color to the copper, which may be useful for applications such as displays and e-readers, where a copper tint is undesirable. Copper films must also be protected from mechanical damage. This can be accomplished by applying a thin layer of protective polymer or other coating over the nanowire film. This coating can have the added benefit of improving the adhesion of the nanowires to the substrate. Examples of such coatings include Teflon, cellulose acetate, ethylcellulose and acrylates.

In another aspect, a copper-containing film comprising, consisting of or consisting essentially of a network of CuNWs and at least one supportive material is processed to remove the supportive material to yield a network of CuNWs. Accordingly, a method of annealing a copper-containing film comprising a network of CuNWs and at least one supportive material is described, said method comprising heating the copper-containing film in a reducing atmosphere at a temperature that removes the supportive material from the copper-containing film to yield a network of CuNWs. Preferably, the reducing atmosphere comprises hydrogen gas and the anneal is carried out at temperature in a range from about 100° C. to about 500° C., preferably about 350° C., for time in a range from about 0.1 min to about 180 min, preferably about 20 min to about 40 min, and most preferably about 30 min.

The high transmittance of conductive films of CuNWs, combined with their extremely low cost, make them a promising transparent conductor for use in displays, low-emissivity windows, and thin film solar cells.

### Example 1

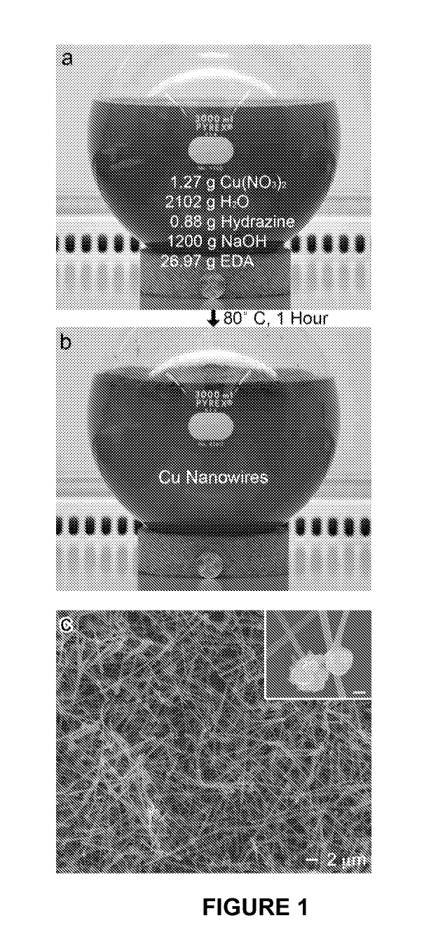

Copper nanowires were synthesized by reducing Cu(NO₃)₂ with hydrazine in an aqueous solution containing NaOH and, ethylenediamine (EDA). For the scale up reaction (FIG. 1), 2000 mL of 15 M NaOH, 100 mL of 0.2 M Cu(NO₃)₂, 30 mL EDA, and 2.5 mL of 35 wt % hydrazine were added to the reaction flask and swirled by hand for 20 seconds after each addition to mix the reactants. This solution was heated at 80° C. and stirred at 200 rpm for 60 minutes. The solution went from a royal blue (FIG. 1A), indicative of Cu²⁺ ions, to a reddish brown color indicative of CuNW formation (FIG. 1B) after 20 minutes. This reaction produced 1.2 grams of CuNWs. After the reaction, the CuNWs were washed with a 3 wt % aqueous solution of hydrazine, and stored in the same hydrazine solution at room temperature under an argon atmosphere to minimize oxidation.

FIG. 1C shows a scanning electron microscope (SEM, FEI XL30) image of the reaction product, consisting of CuNWs with a diameter of 90±10 nm. The inset image shows a close up of the wires, in which it appears spherical nanoparticles are attached to one end of the nanowires. We could observe many similar wires with spherical nanoparticles attached at one end, but initially it was not clear if the wires grew from the spherical nanoparticles, or if the spherical nanoparticles formed at the end of the nanowires in the later stages of their growth.

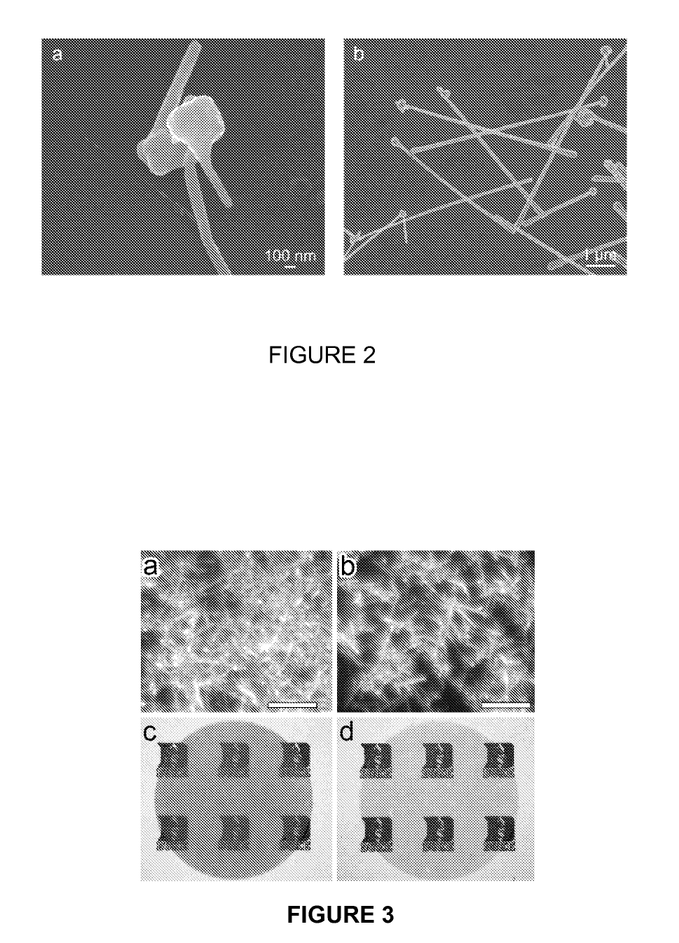

To determine if CuNWs grew from spherical nanoparticles, we stopped the CuNW reaction at different times and examined the products using electron microscopy. These reactions were performed at a smaller scale, with 20 mL 15 M NaOH, 1 mL, 0.1 M Cu(NO₃)₂, 0.15 mL EDA, and 0.025 mL 35 wt % hydrazine. As with the scale-up reaction, the reaction color was initially blue, but became cloudy at 0.5 min, and clear at 3 min. The reaction mixture stayed clear until approximately 3.5 minutes into the reaction, at which time we observed the first copper precipitate suspended in the solution. SEM images of this precipitate (FIG. 2A) revealed CuNWs 100±10 nm in diameter and less than 1 μm in length growing out of spherical copper nanoparticles. After reacting for 20 minutes (FIG. 2B), wires grew to be 6±1 μm in length, and were still attached to the spherical nanoparticles. These images suggest that CuNWs grow from spherical seeds.

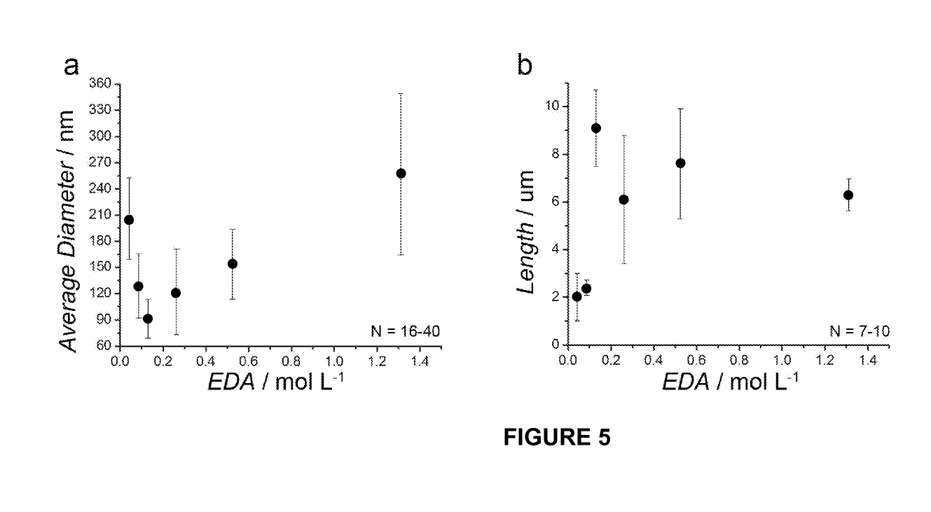

The addition of an amine species such as EDA to the reaction solution may also be necessary to promote anisotropic growth of CuNWs; when EDA was not added to the reaction, wires did not grow. Instead, only spheres with diameters ranging from 125-500 nm were present after 1 hr. Although not wishing to be bound by theory, the amine groups of EDA may bind to the surface of copper nanostructures in solution. To examine the role of EDA as a possible director of anisotropic growth in the reaction, the effect of EDA concentration on the diameter and length of the CuNWs was evaluated. As shown in FIGS. 5A and 5B, as the concentration of EDA was increased from 0.04M to 0.13 M, the diameter of the nanowires decreased from 205 nm to 90 nm, while the length increased from 2 μm to 9 μm. Increasing the concentration of EDA further to 1.31 M increased the diameter by a factor of about three (260 nm) and decreased the length to 6 μm. This data suggests that low concentrations of EDA preferentially cap the sides of the wire, leading to anisotropic growth of long, thin nanowires. Higher concentrations of EDA may cause capping of wire ends as well as the sides, leading to shorter wires with larger diameters.

To disperse the CuNWs, they may be sonicated in an aqueous solution containing 3 wt % of hydrazine solution and 1 wt % PVP. This solution was gently poured on top of 640 ml of an aqueous solution of 10 wt % PVP in a 1000 ml graduated cylinder. The Cu aggregates that were not dispersed during sonication settled to the bottom of the cylinder, leaving the well-dispersed NWs suspended in solution.

To examine their properties as transparent electrodes, the well-dispersed CuNWs were filtered onto 0.6 gm polycarbonate membranes, and printed onto glass microscope slides coated with Aleene's Clear Gel Glue. A thin film (8±0.1 μm, Veeco Dektak 150) of glue was deposited onto the slides with a spin coater (Air Control Spin Coat Hood), and allowed to dry for one hour so that it hardened but remained sticky. The CuNW filtrate on the membrane was then put into contact with the sticky film by hand, and the membrane was peeled away, leaving the CuNWs on the clear glue.

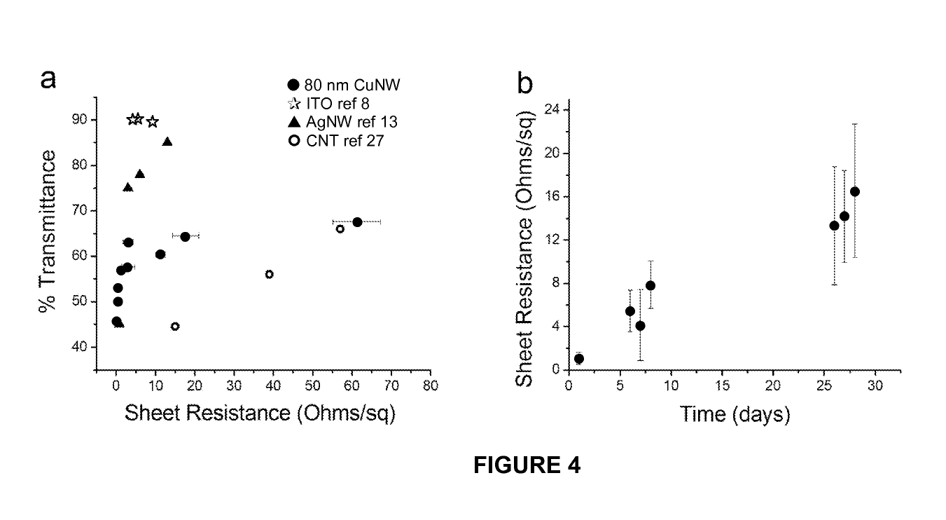

FIGS. 3A & B compare dark-field microscope images of films containing 0.053 and 0.020 g/m² of copper nanowires, respectively. At lower concentrations of nanowires, the open spaces are clearly larger, leading to a transmittance (% T) at λ=500 nm of 67% for FIG. 3B as compared to 38% for FIG. 3A. FIGS. 3C & D show corresponding camera images of CuNW films 35 mm in diameter to visually demonstrate the difference in transparency between these copper nanowire films, as well as their overall uniformity. FIG. 4A shows plots of % T (at λ=500 nm) versus sheet resistance (Rₛ) for films of CuNWs 80 nm in diameter. At a Rₛ=1.5 Ω/sq, the % T was 38%; at Rₛ=61 Ω/sq, the % T was 67%. With these initial results we have already surpassed the best reported values for carbon nanotubes, which are plotted for comparison.

The stability of the CuNW films was analyzed by measuring the sheet resistance of 0.054 g/m² films of copper nanowires over 28 days. FIG. 4B shows that a film of copper nanowires left in air at room temperature remains highly conductive for at least one month. The surprising stability of these films in air suggests that proper packaging can easily ensure the long-term stability of copper nanowires for practical applications.

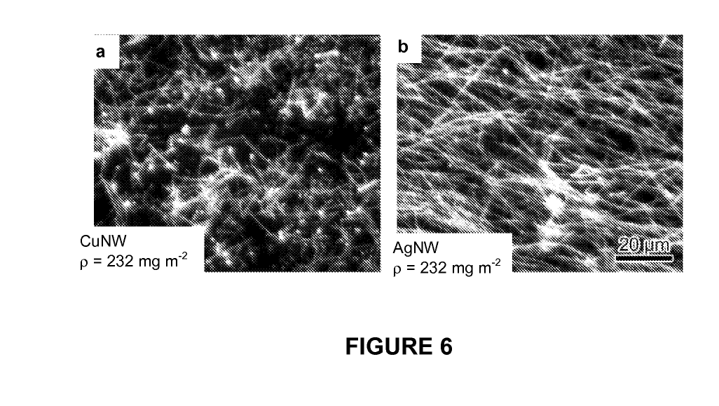

In addition, copper nanowires form aggregates that lower their transmittance relative to uniform films of silver nanowires with the same conductivity. FIGS. 6A and B are images comparing a film of copper nanowires with silver nanowires that illustrate that copper nanowires cluster into aggregates while silver nanowires are uniformly dispersed. Accordingly, a key requirement to optimizing the properties of copper nanowire transparent conducting films is forming a well-dispersed suspension of copper nanowires prior to assembling them into a film to maximize the open area of the film, and ensuring that all copper nanowires in the film contribute to the conductivity of the film.

### Example 2

### Method

General Approach:

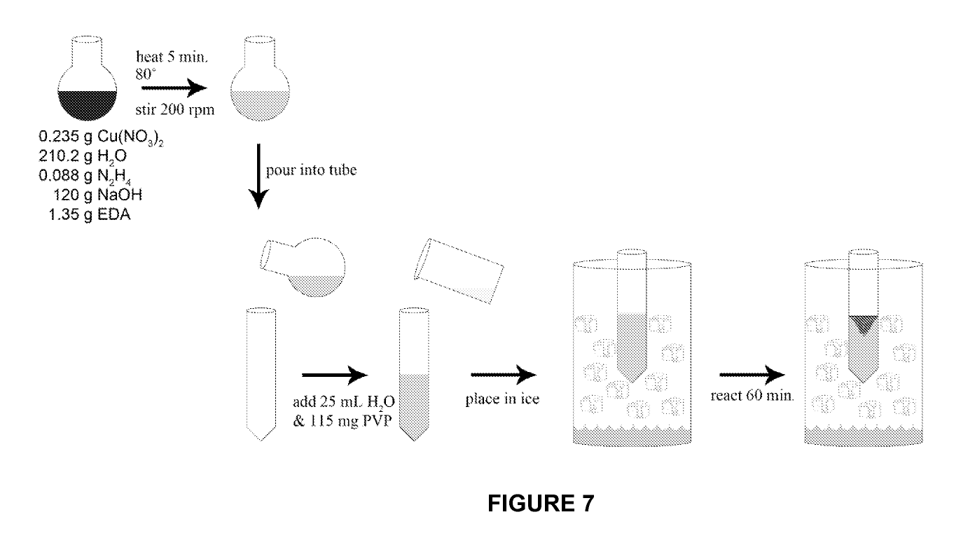

The present disclosure describing a specific procedure represents one method of producing long, well-dispersed copper nanowires. A major problem with current methods of synthesizing copper nanowires is the aggregation and adherence of the newly formed nanowires to one another, resulting in the formation of clumps. When incorporated into films, these clumps lead to poor transparency. The methods described herein, and shown generally in FIG. 7, solve this problem by separating the seed nucleation and wire growth processes into two steps. Although not wishing to be bound by theory, it is thought that by adding surfactant shortly after nucleation of the seeds, the aggregation of the nanowires is prevented during the growth stage.

In one embodiment, the scale-up reaction produces about 60 mg of CuNWs (percent conversion=93%). A 1000 mL round bottom flask was cleaned with nitric acid and rinsed several times to make sure it was clean. The flask was then allowed to dry in an oven set to 80° C. Once dry, the flask was removed from the oven and allowed to cool to room temperature before being used.

The CuNWs were synthesized by adding NoOH (200 mL, 15 M), Cu(NO₃)₂ (10 mL, 0.1 M), ethylenediamine (1.5 mL), and hydrazine (0.25 mL, 35 wt %) to the 1000 mL round bottom flask. This solution was swirled by hand for 20 seconds after each addition to ensure everything was mixed together. The solution was then heated at 80° C. for approximately five (5) minutes while stirring at 200 rpm. When the solution is ready to be removed from the heat, it will have a darker hue to it, but it will not have a brownish/red color. Once removed from the heat, a solution of 25 mL of water and 0.115 grams of polyvinylpyrrolidone (PVP) was gently added to the top of the solution and the mixture was placed in an ice bath for 1 hour. During the 1 hour, CuNWs will start to form on the surface of the mixture. Typically the wires will form under a layer of PVP giving them a light pink color.

After 1 hour in the ice bath the flask was removed and the CuNWs were collected. To collect the CuNWs, the reaction mixture may be transferred to a beaker and allowed to settle for 10-15 minutes. The CuNWs float to the surface of the mixture and can be scooped into a centrifuge tube containing 10 mL of an aqueous solution of hydrazine (3 wt %) and PVP (10 wt %). After all of the CuNWs are transferred to the centrifuge tube, the solution can be decanted and 20 mL of the same hydrazine/PVP can be added to the CuNWs. The wires were then vortexed to disperse the wires before being centrifuged at 2000 rpm for 15 minutes. After being centrifuged, the wires can be further cleaned by repeating this process, e.g., one, two, three, or multiple other times. Once clean, the CuNWs can be stored in the same hydrazine/PVP solution.

As will be recognized by those skilled in the art, the concentration of ingredients, reaction temperature, and reaction times can vary to produce nanowires of similar dimensions and dispersion, or produce nanowires of different dimensions. Table 1 below shows a nonlimiting range of reactants and conditions that produce nanowires in accordance with the present disclosure.

TABLE 1
Minimum and Maximum weight percent of each reactant, temperature,
and time needed to produce copper wires

| Reactants | Minimum | Maximum |
|---|---|---|
| NaOH | 31.16% | 36.13% |
| Copper (II) Nitrate | 0.017% | 0.105% |
| EDA | 0.14% | 3.92% |
| Hydrazine | 0.016% | 0.080% |
| PVP | 0.030% | >0.36% |
| Temperature | 50° C. | 100° C. |
| Time | 1.5 min | >300 min |

Effect of NaOH:

The reaction may be performed in a concentrated solution of NaOH for the formation of CuNWs. When the reaction was conducted in water only particles were formed. The preferred amount of NaOH for a 20 mL scale reaction is in a range from about 9.6 g to about 12 g. When the amount of NaOH falls below 9.6 grams, a blue precipitate (presumably Cu(OH)₂) forms and if the concentration of NaOH exceeds 15 M, the NaOH becomes increasingly difficult to dissolve. If there are solid NaOH pieces within the solution, the reaction will precipitate prematurely and produce only particles. In general, it is assumed that KOH and other strong bases will also be suitable for raising the pH of the solution and facilitating the reduction of copper by hydrazine.

Effect of Hydrazine:

Hydrazine is the preferred reducing agent to reduce the copper(II) ions, e.g., Cu(NO₃)₂, to copper nanowires. The preferred amount of hydrazine is greater than about 8.79 mg for the 20 mL scale reaction. Below 8.79 mg the reaction does not produce as many CuNWs and below 5.3 mg the reaction does not always proceed. When using more than 8.79 mg of hydrazine per reaction, the reaction begins to proceed more quickly and more particles are generated.

Effect of Cu (NO₃)₂:

Copper(II) nitrate is the preferred copper (II) ion source and is preferably in a range from about 5.8 mg to about 23.3 mg for a 20 mL scale reaction. If there is not enough copper (II) nitrate present, the hydrazine will reduce it to particles and no wires will form. At 5.8 mg of copper(II) nitrate, the majority of the precipitate is particles but a few wires are present. When the copper(II) nitrate is increased to 34.9 mg, the solution turns yellow and when observed under a dark field optical microscope, the yellow precipitate appears to be small particles.

Effect of Surfactant:

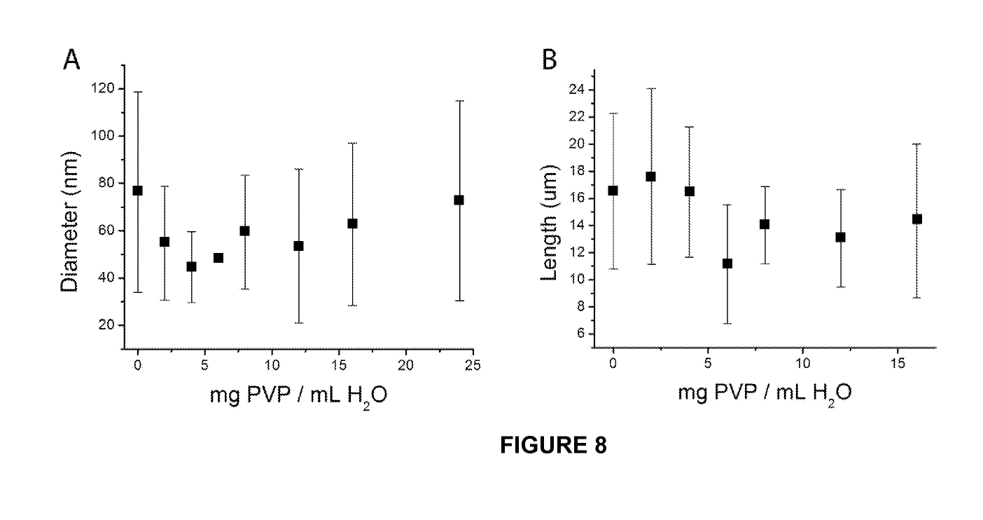

Addition of a surfactant is not necessary for formation of copper nanowires, but it does substantially minimize their aggregation, increase the CuNW length, and decrease the CuNW width. FIGS. 8A and 8B show that the dimensions of copper nanowires are not strongly dependent on the concentration of PVP. However, there is an optimal PVP concentration, approximately 2-4 mg/ml, at which the width of the copper nanowires is minimized, and the length is maximized. All concentrations of PVP above 2 mg/ml produce nanowires that are well-dispersed.

Effect of Time and Temperature.

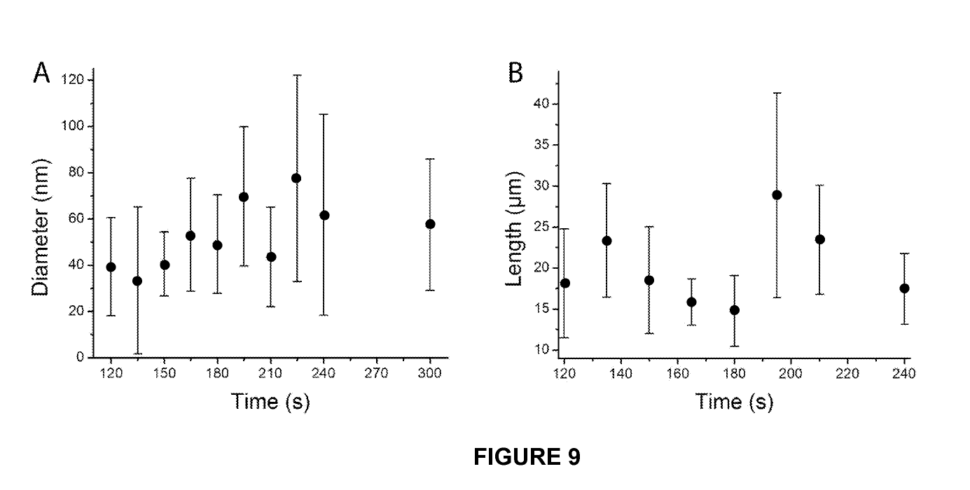

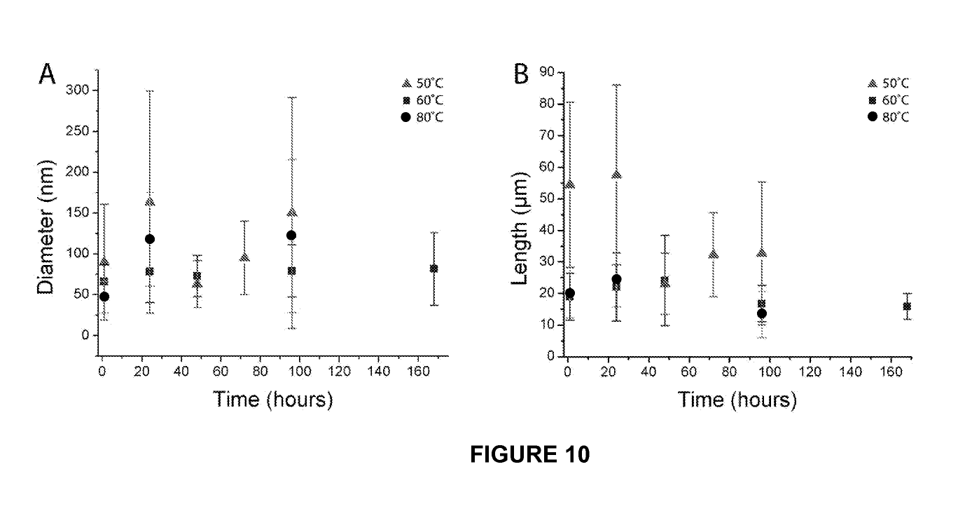

FIGS. 9A and 9B show the effect of time on the diameter and length of CuNWs, respectively. These reactions were completed with a 20 mL, small-scale reaction and the amount of time a reaction spends heating up versus diameter and length, respectively, were graphed. FIGS. 10A and 10B, also completed with a 20 mL, small-scale reaction, show the effect the amount of time the reaction sat at room temperature versus nanowire diameters and lengths, respectively, for three different reaction temperatures. Here, the reaction sat at room temperature because the reactions done at 50 and 60° C. did not precipitate in the ice. The 80° C. reactions were placed in the ice for one hour and then removed for the duration of the experiments.

Recycling the Ingredients:

Table 2 below shows a table presenting a cost comparison of the ingredients in the syntheses of silver and copper nanowires. Notably, the cost of copper nitrate comprises only 4.2% of the cost of the ingredients of making CuNWs.

TABLE 2
Cost comparison of the reactants required to
synthesize Cu and Ag nanowires.*

| Reactants | $/g | g/reaction | |
|---|---|---|---|
| | | | $/g CuNWs |
| NaOH | 0.003 | 2000 | 6.000 |
| copper (II) nitrate | 0.066 | 3.876 | 0.256 |
| EDA | 0.100 | 22.475 | 2.248 |
| hydrazine | 1.205 | 1.465 | 1.765 |
| PVP | 0.164 | 1.917 | 0.315 |
| | | $/g CuNWs: | 10.583 |
| | | | $/g AgNWs |
| ethylene glycol | 0.067 | 222.880 | 27.004 |
| silver (I) nitrate | 3.168 | 0.872 | 5.023 |
| PVP | 0.352 | 0.872 | 0.558 |
| NaCl | 1.064 | 0.003 | 0.005 |
| iron (III) nitrate | 0.266 | 0.001 | 0.000 |
| | | $/g AgNWs: | 32.590 |

*The price of the reactants was taken from Sigma-Aldrich, except for EG, which was taken from Mallinckrodt Baker, and, NaOH, which was taken from Duda Diesel. The prices were current as of August 2010. The time and energy required to synthesize the wires is comparable.

By simply filtering out any copper precipitate from the reaction solution, the ingredients can be reused for another round of synthesis. By reusing the unreacted ingredients, the material cost of the copper nanowires could be reduced from $6/g to $1/g. This cost reduction assumes recycling of the NaOH and EDA solutions, but the hydrazine and copper nitrate will need to be replenished.

Method—Scalable Process and Formula:

The methods presented herein have been scaled up by 100 times (from 0.01 to 1 g) with little change in the reaction product. Indeed, larger reaction scales often lead to more stable temperatures, and thus more reproducible results. Scaling this reaction to produce 1 kg or more per batch can be readily accomplished by carrying out the reaction in a vessel exceeding 3,000 L in size. Inexpensive polymer tanks exceeding 10,000 L are commercially available and are likely suitable for carrying out the reaction at scales exceeding 1 kg. At these scales stirring with a magnetic stir bar can be replaced by a mechanically driven, propeller type, stirrer. Heating can be accomplished with an immersion type heater. After the reaction is complete, the nanowires can be removed from the top of the reaction with a skimming or suction process. Centrifugation can be replaced with filtration, settling, or other colloidal separation processes to wash the wires. The unreacted ingredients can be drained from the vessel and sent through a number of separation processes (e.g. filtration) for reuse.

Effect on Nanowire Dispersion and Length on their Properties in Transparent Conducting Films:

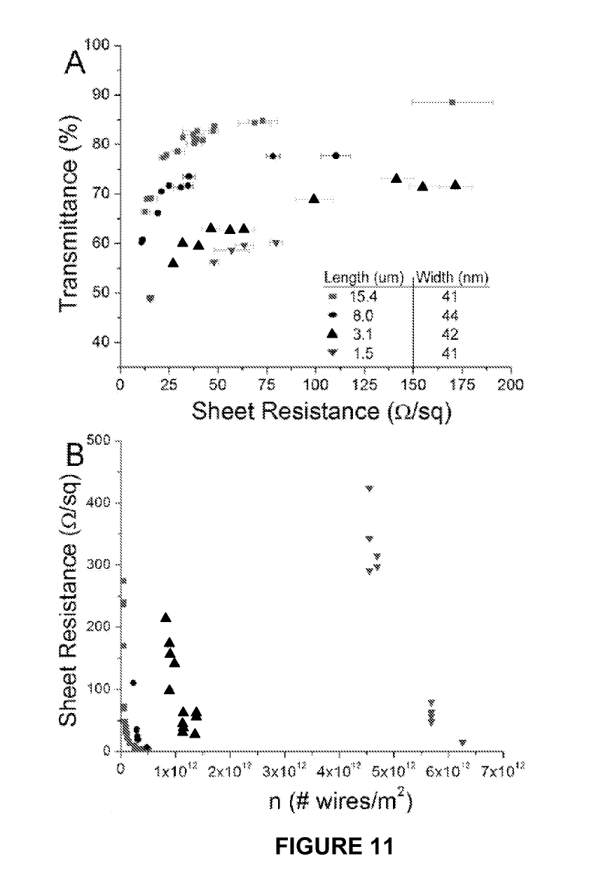

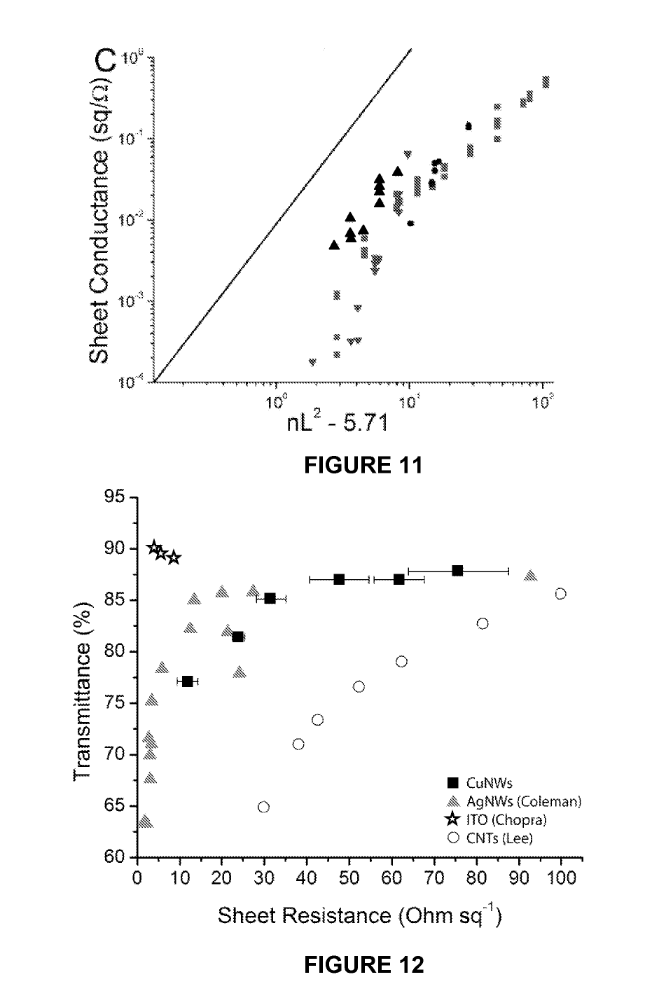

Percolation theory predicts that the number density of nanowires required to make a conductive network decreases with length (see FIGS. 11A, B and C). The fact that the aforementioned synthesis produces nanowires that are twice as long compared to a synthesis that does not use surfactant means that the number density of wires necessary for making a conductive film will be reduced by four times. This, in turn, will result in an improved transmittance at a given conductivity. In addition, the reduced aggregation will ensure that each nanowire will contribute to conductivity instead of just blocking light.

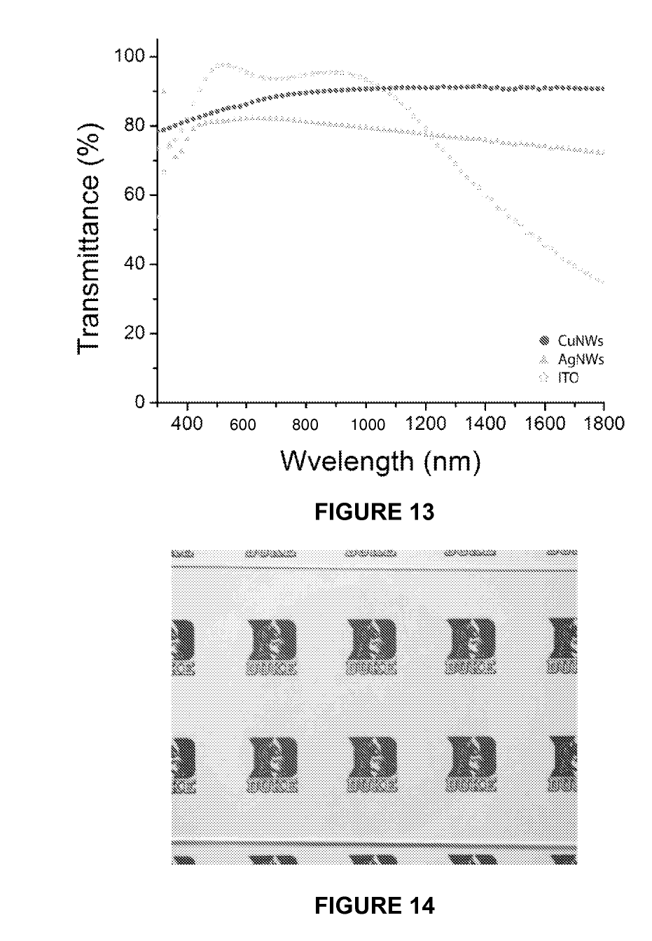

FIG. 12 shows that both the improved length and the reduced clumping result in an improvement of the properties of copper nanowire films to be on par or better than films of silver nanowires. Although films of indium tin oxide (ITO) are more transparent in the visible region of the electromagnetic spectrum, films of copper nanowires are much more transparent at telecommunication wavelengths (˜1500 nm, see FIG. 13).

Making Films of Nanowires:

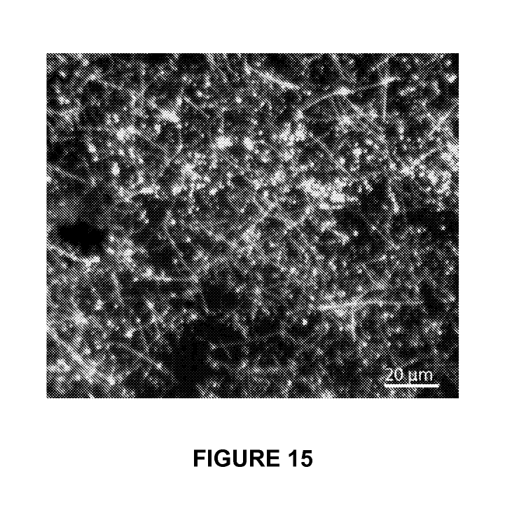

FIG. 14 shows a circular film of copper nanowires that has been formed by filtering the copper nanowires, and printing the wires onto a piece of glue. FIG. 15 is a dark field microscope image showing scattering of light from the nanowires as well as from particles/dust/defects on the substrate. Note that the nanowires are present as individual wires rather than clumps. This film has a conductivity of 10 Ω/sq and a transmittance of 85%. We also found that spraying the nanowires with an airbrush onto a substrate results in films with similar properties.

Flexibility of Nanowire Films:

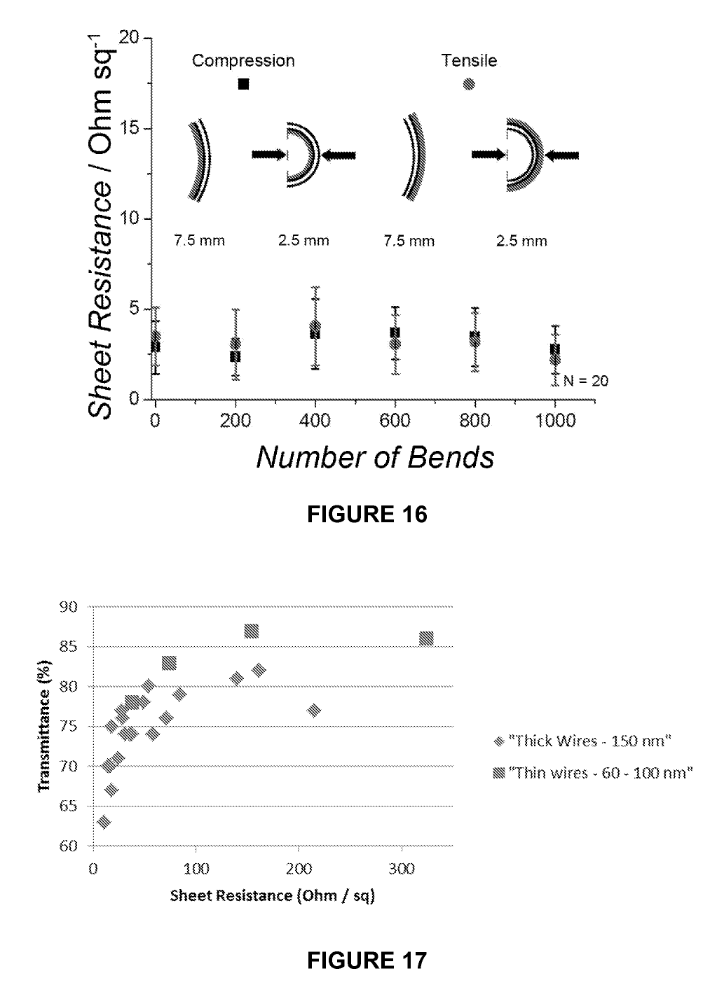

To test the use of CuNW films as a flexible electrode, films with a transmittance of 60% were subjected to both compression and tensile bending, and the sheet resistance measured every 200 bend cycles. FIG. 16 shows that each film started with a radius of curvature of 7.5 mm, and was bent until it reached a radius of curvature of 2.5 mm. There was no change in sheet resistance after 1,000 bending cycles. For comparison, ITO films cannot be bent beyond a radius of 10 mm without losing conductivity.

### Example 3

Another synthesis was developed that resulted in the production of CuNWs about 50 nm in diameter and many nanowires having lengths exceeding 20 μm.

Flasks and stir bars were cleaned with concentrated nitric acid, thoroughly rinsed with DI water, and dried in an 80° C. oven before use. Once dry, the flasks were allowed to cool to room temperature before any reactants were added.

CuNWs were synthesized by adding NaOH (20 mL, 15M), Cu(NO₃)₂ (1 mL, 0.1M), EDA (0.15 mL), and hydrazine (0.025 mL, 35 wt %) to a 50 mL round bottom flask. This mixture was swirled by hand for 5 seconds after each addition to mix the reactants. The solution was then heated at 80° C. and stirred at 200 rpm for approximately 3 minutes. After the reaction, the solution was poured into a 50 mL centrifuge tube and a PVP and water solution (20 mg PVP in 5 mL of water) was gently added to the top. The reaction solution and PVP solution were not mixed before being put in an ice bath. The solution was allowed to finish reacting in the ice for 1 hour before being transferred to a beaker. The solution was allowed to settle, allowing the CuNWs to float to the top of the solution before being scooped into 15 mL of hydrazine (3 wt %), PVP (1 gram), and water (97 mL). The solution was centrifuged at 2000 rpm for 20 minutes, and the supernate was decanted from the nanowires. The wires were then dispersed in the aqueous solution of hydrazine and PVP by vortexing for 30 seconds, and then centrifuged and decanted for 3 more cycles. The CuNWs were stored in the 3 wt % hydrazine/PVP solution at room temperature under an argon atmosphere to minimize oxidation.

The dispersed CuNWs were printed onto a substrate using the Mayer rod printing method. A printing formulation was prepared by adding 3 grams of the 5 wt % ethyl cellulose solution to a 20 mL scintillation vial. Then 0.25 grams of ethyl acetate, 0.5 grams isopropanol, 1 mL toluene, and 0.5 grams of pentyl acetate were added to the vial, wherein after each addition the solution was vortexed for 30 seconds to ensure good mixing.

Prior to printing, four small scale CuNW formation reactions were combined into one centrifuge tube. Once combined, the solution was centrifuged at 2000 rpm for 5 minutes. The supernatant was decanted and 20 mL of ethanol was added and then vortexed to ensure good dispersion. This process was repeated for a total of 3 centrifugation cycles. Once the wires were cleaned three times with ethanol, the wires were dispersed in as little ethanol as possible, ˜1-2 mL. Thereafter, 0.5 mL of the copper nanowire solution was pippetted into a 1.5 mL centrifuge tube. 0.5 mL of the printing formulation was then added and the centrifuge tube vortexed for 30 seconds, sonicated for 10 seconds, and then re-vortexed for an additional 30 seconds to break up as many of the aggregates as possible. The resulting formulation comprises copper nanowires ready for printing.

To make a film using the Mayer Rod technique, a clipboard was taped to a flat service with double sided tape. A glass microscope slide or piece of plastic was then placed in the clip of the clip board. 25 μL of the copper nanowire formulation was then evenly spread in a line at the top of the glass slide. Then a Mayer Rod with a specified wire gauge was placed between the copper nanowire line and the clip and then quickly pulled to the bottom of the glass slide. The amount of pressure applied to the Mayer Rod was minimal. The film was then allowed to dry in air. The transmittance of the film can be measured once the film is dry in order to gauge how transparent it will be once the process is finished, keeping in mind that once the ethyl cellulose is burned off the transmittance will increase. The thickness of the film can be changed by 1) using a different Mayer Rod with a different wire gauge or 2) diluting/concentrating the copper nanowire formulation.

Once the desired films were made, the glass slides with the films were cut into pieces of ˜0.5 inches. The glass pieces were then placed in a tube furnace, under hydrogen flowing at 250 mL/min for 10 minutes. After the system was flushed with hydrogen the furnace was brought up to 350° C. for 30 minutes. After 30 minutes the system was allowed to cool to room temperature before removing the glass pieces from the tube. Finally the sheet resistance and final transmittance were measured and recorded. The results are illustrated in FIG. 17.

### Example 4

### Silver Coating Reaction

The CuNWs were cleaned prior to being coated with silver. 5 mL of a dispersed copper nanowire solution was washed twice using 10 mL of 1 wt % PVP (MW=10,000) solution and centrifuging at 2000 rpm for 10 minutes. The resulting wires were diluted to 5 mL with the 1 wt % PVP solution.

Straight stir bars were cleaned with concentrated nitric acid, rinsed with deionized water, and dried in an 80° C. oven before use.

10 mL of deionized water was added to a 20 mL scintillation glass vial with a stir bar spinning at 300 rpm. Thereafter, 1 mL of the cleaned copper nanowire solution and an excess amount of 0.01 M hydroquinone solution were added to the vial. The desired amount of 0.1 M silver nitrate solution, as readily determined by the skilled artisan, was added for the desired ratio of moles of silver nitrate to moles of copper. The reaction turned from a light red color to gray within several seconds. The wires may be stored in the vial at room temperature.

### Example 5

### Nickel Coating Reaction

The CuNWs, stored in 3 wt % hydrazine and 4 wt % PVP are centrifuged and washed twice with a 4 wt % PVP solution. Wires are spun at 2000 rpm for 5 minutes. Wires are concentrated into a 4 wt % PVP solution.

Egg-shaped stir bars were cleaned with concentrated nitric acid, thoroughly rinsed with DI water, and dried in a 80° C. oven before use.

Copper nanowires are coated by adding the following reactants, listed by order, into a disposable 10 mL vial:
1. 5 mg CuNW in 2˜3 mL of 4 wt % PVP
2. A specific amount of Ni(NO₃)₂.6H₂O diluted to 2 mL H₂O. For example, to make a 2:1 atom ratio Ni:Cu reaction with 5 mg Cu, 1570 μL 0.1M Ni(NO₃)₂.6H₂O and 430 μL DI water were added to the vial.
3. 10 mL 15M NaOH
4. Egg-shaped stir bar
5. 9 μL 35% weight hydrazine
   The vial was then heated in a 55° C. water bath with a 600 rpm stir rate for 40 minutes.

After the vial was taken out of the water bath, the reaction is transferred to a centrifuge tube. A 3 wt % hydrazine, 4 wt % PVP solution was added to precipitate PVP and aggregate the wires. The sodium hydroxide was decanted, and a 3 wt % hydrazine, 4 wt % PVP solution was added again. The reaction was thoroughly vortexed to disperse the wires. The reaction is centrifuged twice (2000 rpm, 5 min) and washed twice with a solution of 3 wt % hydrazine, 4 wt % PVP and stored in room temperature.

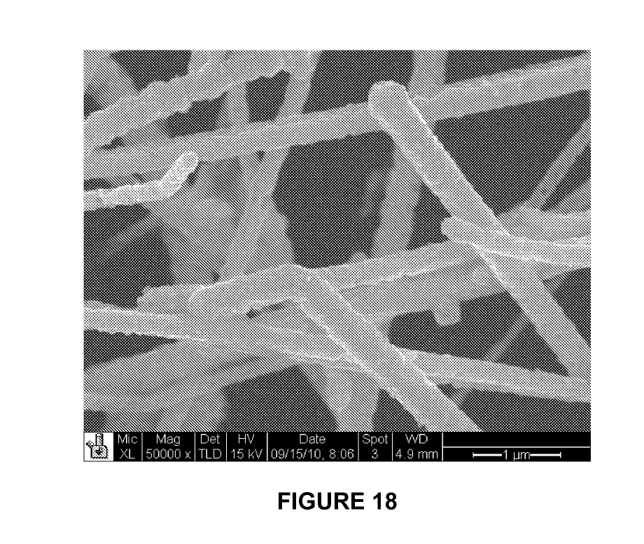

Unlike the Ag—Cu system, Ni and Cu do alloy. These characteristics make Ni a promising material for coating of the Cu Nanowires. We have been able to obtain copper nanowires with Ni sheaths, as seen in FIG. 18.

### Example 6

We have recently calculated the effect of width on the transmittance of a copper nanowire film at percolation. Percolation is the minimum density of nanowire required to make a conducting network. It has been found theoretically that the percolation of a network of sticks depends on the density N and length L of the sticks, as given by equation 1:

N_{c}L²=5.71 (1)

We have recently calculated and experimentally determined that the transmittance % T of a nanowire film depends on area coverage A_{c} as given by equation 2:

%T=−74A_{c}+96.9 (2)

where A_{c} is given by equation 3:

A_{c}=N·w·L (3)

where w is the width of the nanowires. To illustrate the quantitative effect of width on the transmittance of a percolating nanowire network, the percent transmittance of the nanowires vs. width was plotted in FIG. 21.

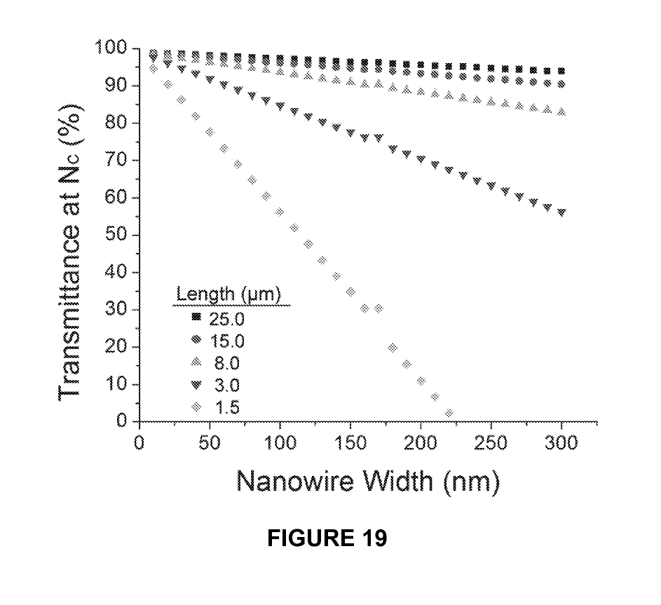

FIG. 19 illustrates that better transmittances are obtained with thinner, longer nanowires. Although not wishing to be bound by theory, it is assumed that if the width of the nanowires is decreased below 50 nm, the resistivity of the copper will increase due to scattering of electrons off the sides of the wires. Furthermore, the wires will lose their stiffness and become more like noodles than sticks which will decrease their effective length and thus the performance of the films. These theoretical results support the experiments that indicate the wires obtained by example 3 represent a preferred length and width for obtaining films with high transmittances and conductivities.

### REFERENCES

Alm, J. et al., Heterogeneous Three-Dimensional Electronics by Use of Printed Semiconductor Nanomaterials. Science 314, 1754-1757 (2006).
Chang, Y., Lye, M. L., Zeng, H. C., Large-Scale Synthesis of High-Quality Ultralong Copper Nanowires. Langmuir 21, 3746-3748 (2005).
Chang, Y., Hong, F., The Fabrication of ZnO Nanowire Field-Effect Transistors by Roll-Transfer Printing. Nanotech. 20, 195302 6 pp (2009).
Chena, Z., Cotterell, B., Wang, W., Guenther, E., Chuab, S. A mechanical assessment of flexible optoelectronic devices. Thin Solid Films 394, 202-206 (2001).
Chopra, K., Major, S., Pandya, D., Transparent Conductors—A status Review. Thin Solid Films 102, 1-46 (1983).
De, S., et al., Silver Nanowire Networks as Flexible, Transparent, Conducting Films: Extremely High DC to Optical Conductivity Ratios. ACSNano 3, 1767-1774 (2009).
De, S. et al., Transparent, Flexible, and Highly Conductive Thin Films Based on Polymer Nanotube Composites. ACSNano. 2009, 3, 714-720.
Forrest, S., The Path to Ubiquitous and Low-cost Organic Electronic Appliances on Plastic. Nature 428, 911-918 (2004).
Gordon, R., Criteria for Choosing Transparent Conductors. MRS Bulletin 25, 52-57 (2000).
Kaempgen, M., Duesberg, G., Roth, S., Transparent Carbon Nanotube Coatings. Applied Surface Science 252, 425-429 (2005).
Kim, H., Jeong, J., Choi, K., Jeong, S., Kang, J., Characteristics of Flexible ITO Electrodes Grown by Continuous Facing Target Roll-to-Roll Sputtering for Flexible Organic Solar Cells. Electrochemical and Solid State Letters 12, 169-172 (2009).
Lagemaat, J. et al., Organic Solar Cells With Carbon Nanotubes Replacing In203:Sn as the Transparent Electrode. App. Phys. Lett. 88, 233505 1-3 (2006).
Taylor, S., McLennan, S., The Geochemical Evolution of the Continental Crust. Reviews of Geophysics 33, 241-265 (1995).
U.S. Geological Survey, Mineral Commodity Summaries. Indium. 76-77 (2009).
U.S. Geological Survey, Mineral Commodity Summaries. Silver. 148-149 (2009).
Wiley, B., Sun, Y., Xia, Y., Synthesis of Silver Nanostructures with Controlled Shapes and Properties. Acc. Chem. Res. 40, 1067-1076 (2007).
Zhou, Y., Hu, L., Gruner, G. A., Method of Printing Carbon Nanotube Thin Films App. Phys. Lett. 88, 123109 1-3 (2006).

Any patents or publications mentioned in this specification are indicative of the levels of those skilled in the art to which the invention pertains. These patents and publications are herein incorporated by reference to the same extent as if each individual publication was specifically and individually indicated to be incorporated by reference.

One skilled in the art will readily appreciate that the present invention is well adapted to carry out the objects and obtain the ends and advantages mentioned, as well as those inherent therein. The present examples along with the methods, procedures, treatments, molecules, and specific compounds described herein are presently representative of preferred embodiments, are exemplary, and are not intended as limitations on the scope of the invention. Changes therein and other uses will occur to those skilled in the art which are encompassed within the spirit of the invention as defined by the scope of the claims.

1. A conductive film comprising a network of copper nanowires (CuNWs), said conductive film having a sheet resistance of less than about 10,000 Ω/sq.

2. The conductive film of claim 1, wherein the conductive film has a transparency greater than about 60%.

3. The conductive film of claim 1, wherein the conductive film further comprises at least one supportive material, wherein the supportive material is selected from the group consisting of cellulose materials, glues, polymeric materials, glass, and overcoat materials.

4. The conductive film of claim 1, wherein the copper nanowires comprise a copper stick attached to a spherical copper nanoparticle, and wherein the stick has a first end and a second end.

5. (canceled)

6. The CuNW of claim 4, wherein the spherical copper nanoparticle has a diameter of about 30 to 1000 nm attached to either the first end or the second end of the stick.

7. The CuNW of claim 4, wherein the copper stick comprises a length of about 1 to 500 microns and a diameter of about 20 to 300 nm.

8. The CuNW of claim 1, further comprising a protective film over the copper nanowires, wherein the protective film comprises an organic molecule known to protect copper from corrosion, a coating of nickel, gold, tin, zinc, silver, or an alloy thereof, or a thin layer of protective polymer.

9. (canceled)

10. A dispersion of copper nanowires, comprising copper nanowires (CuNWs) and a dispersion solution, wherein the CuNWs are substantially free from aggregation.

11. The dispersion of claim 10, wherein the dispersion solution comprises at least one of hydrazine, a surfactant, an alcohol, water, or a combination thereof.

12. (canceled)

13. A method of producing copper nanowires (CuNWs), said method comprising:
mixing a copper (II) ion source, at least one reducing agent, at least one copper capping agent, and at least one pH adjusting species to form a first solution;
maintaining the first solution for time and temperature necessary to reduce the copper (II) ions;
adding a second solution comprising water and at least one surfactant to create a mixture; and
maintaining the mixture at time and temperature necessary to form CuNWs.

14. The method of claim 13, wherein said maintaining the first solution comprises heating at temperature in a range from about 60° C. to about 100° C.

15. (canceled)

16. The method of claim 14, further comprising, prior to adding the second solution, removing the first solution from heat.

17. The method of claim 13, wherein said maintaining the mixture comprises cooling.

18. The method of claim 13, further comprising collecting the formed CuNWs and washing the formed CuNWs with a wash solution.

19. (canceled)

20. The method of claim 13, wherein the copper (II) ion source comprises a species selected from the group consisting of copper nitrate, copper sulfate, copper nitrite, copper sulfite, copper acetate, copper chloride, copper bromide, copper iodide, copper phosphate, copper carbonate, and combinations thereof;
wherein the reducing agent comprises a species selected from the group consisting of hydrazine, ascorbic acid, L(+)-ascorbic acid, isoascorbic acid, ascorbic acid derivatives, oxalic acid, formic acid, phosphites, phosphorous acid, sulfites, sodium borohydride, and combinations thereof;
wherein the copper capping agent comprises a species selected from the group consisting of triethylenediamine; ethylenediamine (EDA); propane-1,3-diamine; butane-1,4-diamine; pentane-1,5-diamine; ethylenediaminetetraacetic acid (EDTA), 1,2-cyclohexanediamine-N,N,N′,N′-tetraacetic acid (CDTA), glycine, ascorbic acid, iminodiacetic acid (IDA), nitrilotriacetic acid, alanine, arginine, asparagine, aspartic acid, cysteine, glutamic acid, glutamine, histidine, isoleucine, leucine, lysine, methionine, phenylalanine, proline, serine, threonine, tryptophan, tyrosine, valine, gallic acid, boric acid, acetic acid, acetone oxime, acrylic acid, adipic acid, betaine, dimethyl glyoxime, formic acid, fumaric acid, gluconic acid, glutaric acid, glyceric acid, glycolic acid, glyoxylic acid, isophthalic acid, itaconic acid, lactic acid, maleic acid, maleic anhydride, malic acid, malonic acid, mandelic acid, 2,4-pentanedione, phenylacetic acid, phthalic acid, proline, propionic acid, pyrocatecol, pyromellitic acid, quinic acid, sorbitol, succinic acid, tartaric acid, terephthalic acid, trimellitic acid, trimesic acid, tyrosine, xylitol, salts and derivatives thereof, and combinations thereof; and
wherein the pH adjusting species comprise a species selected from the group consisting of sodium hydroxide; potassium hydroxide; cesium hydroxide; rubidium hydroxide; magnesium hydroxide; calcium hydroxide; strontium hydroxide; barium hydroxide; and compounds of the formula NR¹R²R³R⁴OH.

21.-27. (canceled)

28. The method of claim 13, wherein the surfactant comprises a species selected from the group consisting of polyethylene glycol (PEG), polyethylene oxide (PEO), polypropylene glycol, polyvinyl pyrrolidone (PVP), cationic polymers, nonionic polymers, anionic polymers, hydroxyethylcellulose (HEC), acrylamide polymers, poly(acrylic acid), carboxymethylcellulose (CMC), sodium carboxymethylcellulose (Na CMC), hydroxypropylmethylcellulose, polyvinylpyrrolidone (PVP), BIOCARE™ polymers, DOW™ latex powders (DLP), ETHOCEL™ ethylcellulose polymers, KYTAMER™ PC polymers, METHOCEL™ cellulose ethers, POLYOX™ water soluble resins, SoftCAT™ polymers, UCARE™ polymers, gum arabic, sorbitan monolaurate, sorbitan monopalmitate, sorbitan monostearate, sorbitan tristearate, sorbitan monooleate, sorbitan trioleate, polyoxyethylene (20) sorbitan monolaurate, polyoxyethylene (20) sorbitan monopalmitate, polyoxyethylene (20) sorbitan monostearate, polyoxyethylene (20) sorbitan monooleate, polyoxyethylene sorbitan trioleate, polyoxyethylene sorbitan tristearate, cetyltrimethylammonium bromide (CTAB), hexadecyltrimethylammonium bromide (HTAB), cetyltrimethylammonium hydrogen sulfate; sodium dodecyl sulfate, ammonium alkyl sulfates, alkyl (C₁₀-C₁₈) carboxylic acid ammonium salts, sodium sulfosuccinates and esters thereof, dioctyl sodium sulfosuccinate, alkyl (C₁₀-C₁₈) sulfonic acid sodium salts, di-anionic sulfonate surfactants, t-octylphenoxypolyethoxyethanol, other octoxynols, and combinations thereof.

29. The method of claim 13, wherein the surfactant comprises PVP.

30. The method of claim 13, wherein the surfactant and water are not mixed together prior to adding to the solution.

31. The method of claim 13, further comprising storing the formed CuNWs in a solution comprising a hydrazine, a surfactant, an alcohol, or combinations thereof.

32. A method of making a conductive film comprising a network of copper nanowires (CuNWs), said conductive film having a sheet resistance of less than about 10,000 Ω/sq, said method comprising printing the CuNWs dispersion of claim 10 onto a substrate.

33. (canceled)

34. (canceled)
